(19) United States
(12) Patent Application Publication
(10) Pub. No.: US 2025/0219321 A1
(43) Pub. Date: Jul. 3, 2025

(54) HIGH VOLTAGE ELECTRICAL CONNECTOR

(71) Applicant: Lear Corporation, Southfield, MI (US)

(72) Inventors: Jin Li, Shanghai (CN); Chao Fang, Shanghai (CN)

(73) Assignee: Lear Corporation, Southfield, MI (US)

(21) Appl. No.: 18/924,024

(22) Filed: Oct. 23, 2024

(30) Foreign Application Priority Data
Dec. 28, 2023 (CN) 202311855496.6

(51) Int. Cl. H01R 13/627; H01R 13/514; H01R 13/639; H01R 13/64; H01R 13/6581

(52) U.S. Cl. CPC H01R 13/6273; H01R 13/514; H01R 13/639; H01R 13/64; H01R 13/6581

(57) ABSTRACT

An electrical connector includes a connector housing with a connector body. A connector cavity extends through the connector body and defines a connector axis. A shroud is connected to the connector body by a shroud wall. The shroud defines a window. A latch is attached to the connector housing for movement relative to the connector body between a latched position and a release position. The latch is located at least partially between the shroud and the connector body. The latch has a block that is adapted to engage a corresponding catch on a corresponding connector in order to retain the electrical connector in a mated position relative to the corresponding connector. The latch also includes a lift bar. The window is adapted to allow a tool to be inserted through the window to engage the lift bar.

### FIELD

This disclosure relates to an electrical connector. More specifically, this disclosure relates to a high voltage electrical connector that includes an improved connector position assurance.

### BACKGROUND

Electrical components are often connected to each other using conductive cables, and electrical connectors attached to the cables allow the components to be connected at a desired time. For example, electrical components from different sources can be brought together during the manufacture of a larger assembly. In order to ensure that the components are properly connected during assembly, it is known to use a connector position assurance on an electrical connector. The connector position assurance is typically located on first electrical connector and can only be moved to its locked position once the first electrical connector is properly mated with the corresponding second electrical connector. Once it is in the locked position, the connector position assurance prevents the first and second electrical connectors from being separated from each other. It is desirable to provide an improved electrical connector and an improved connector position assurance for an electrical connector.

### SUMMARY

Various example electrical connectors are described.

An example electrical connector includes a connector housing. The connector housing has a connector body. A connector cavity extends through the connector body and defines a connector axis. A shroud is connected to the connector body by at least one shroud wall. The shroud defines a window. A latch is attached to the connector housing for movement relative to the connector body between a latched position and a release position. The latch is located at least partially between the shroud and the connector body. The latch has a block that is adapted to engage a corresponding catch on a corresponding connector in order to retain the electrical connector in a mated position relative to the corresponding connector. The latch also includes a lift bar. The window is adapted to allow a tool to be inserted through the window to engage the lift bar.

Another example electrical connector includes a terminal housing located in the connector cavity. The terminal housing includes a terminal cavity adapted to accommodate an electrical terminal. The terminal cavity defines a cavity axis that extends through a contact opening of the terminal cavity. The cavity axis also extends through a connection opening of the terminal cavity. The terminal housing includes an insertion opening that extends from the terminal cavity and is adapted to allow the electrical terminal to be inserted into the terminal cavity in an insertion direction that is substantially perpendicular to the cavity axis. The electrical connector also includes a terminal position assurance. The terminal position assurance is movable relative to the terminal housing in the insertion direction to an installed position. A TPA latch engages a TPA catch to retain the terminal position assurance in the installed position. When in the installed position, the terminal position assurance covers the insertion opening.

Another example includes a terminal housing that includes a tab seat that extends from the terminal cavity and is adapted to accommodate a tab on the electrical terminal. The terminal housing also includes a stop that is fixed relative to the terminal cavity extends from a wall of the terminal cavity toward the cavity axis and is located between the tab seat and the connection opening. Additionally, the terminal position assurance includes a tab lock that extends partially into the tab seat when the terminal position assurance is in the installed position. A contact guide on the terminal position assurance is located adjacent to the contact opening. The contact guide defines a contact hole, and the cavity axis passes through the hole. The electrical connector includes a shield that is located around the terminal housing and the terminal position assurance. The shroud on the connector housing is connected to the connector housing by two shroud walls. Each shroud wall defines an assurance slot that extends parallel to the connector axis. The latch is connected to the shroud walls for movement relative to the connector body. The electrical connector also includes a connector position assurance. The connector position assurance is attached to the connector housing for relative movement parallel to the cavity axis between a pre-lock position and a lock position. The connector position assurance includes an assurance body. Assurance guides are located on opposite side of the assurance body. Each assurance guide is located in a respective one of the assurance slots. An assurance lock is located on each of the assurance guides. An assurance arm also extends from the assurance body parallel to the cavity axis. The block on the latch is adapted to engage a corresponding catch on a corresponding connector to retain the electrical connector in a mated position relative to the corresponding connector. The cavity axis of the terminal housing is parallel to the connector axis. Assembly locks on the shield engage the connector body to retain the terminal housing in place relative to the connector housing. When the connector position assurance is in the pre-lock position, the assurance arm engages the block on the latch to prevent the connector position assurance from being moved in the mate direction relative to the connector housing. When the connector position assurance is in the lock position, the assurance arm engages the block to restrict the connector position assurance from being moved opposite the mate direction relative to the connector housing. Also, when the connector position assurance is in the lock position, the assurance arm is located at least partially between the lift bar and the window.

Additional understanding of these examples will become apparent to those skilled in the art from the following detailed description, when read in light of the accompanying drawings.

### BRIEF DESCRIPTION OF THE DRAWINGS

FIG. 1 is a front perspective view of an example electrical connector.

FIG. 2 is a partially exploded view of the electrical connector illustrated in FIG. 1.

FIG. 3 is a front perspective view of an electrical terminal for use in the electrical connector illustrated in FIGS. 1 and 2.

FIG. 4 is a front perspective view of a terminal housing of the electrical connector illustrated in FIGS. 1 and 2.

FIG. 5 is a top plan view of the terminal housing illustrated in FIG. 4.

FIG. 6 is a front plan view of the terminal housing illustrated in FIG. 4.

FIG. 7 is a view similar to FIG. 5, with electrical terminals shown inserted into the terminal housing.

FIG. 8 is a view similar to FIG. 6, with electrical terminals shown inserted into the terminal housing.

FIG. 9 is a front perspective view of the terminal housing illustrated in FIG. 4, as well as a terminal position assurance.

FIG. 10 is a bottom perspective view of one part of the terminal position assurance illustrated in FIG. 9.

FIG. 11 is a cross-sectional view taken along the line 11-11 in FIG. 10.

FIG. 12 is view similar to FIG. 9, with the terminal position assurance shown attached to the terminal housing, as well as two pieces of a shield.

FIG. 13 is a view similar to FIG. 11, shown with the terminal position assurance attached to the terminal housing.

FIG. 14 is a view similar to FIG. 12, with the shield pieces and a cable shown attached to the terminal housing.

FIG. 15 is an exploded view of a connector housing assembly illustrated in FIG. 2, including a connector housing, a housing seal, a seal retainer, and a connector position assurance.

FIG. 16 is an enlarged, front view of a portion of the connector housing illustrated in FIG. 15, showing a connector latch.

FIG. 17 is a cross sectional view taken along the line 17-17 in FIG. 16.

FIG. 18 is an enlarged, front perspective view of the connector position assurance.

FIG. 19 is a cross-sectional view of the assembled electrical connector, taken along the line 19-19 in FIG. 1.

FIG. 20 is a cross sectional view taken along the line 20-20 in FIG. 19.

FIG. 21 is a cross sectional view taken along the line 21-21 in FIG. 19.

FIG. 22 is a cross sectional view taken along the line 22-22 in FIG. 19, with the connector position assurance shown in a pre-lock position.

FIG. 23 is a cross-sectional view taken along the line 23-23 in FIG. 22.

FIG. 24 is a view similar to FIG. 22, with the latch stop shown in a latched position relative to a corresponding catch.

FIG. 25 is view similar to FIG. 24, with the latch shown in a release position.

FIG. 26 is a view similar to FIG. 25, with the corresponding catch shown in a mated position, the latch shown in the latched position, and the connector position assurance shown in a lock position.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first shield could be termed a second shield, and, similarly, a second shield could be termed a first shield, without departing from the scope of the various described embodiments. The first shield and the second shield are both shields, but they are not the same shield.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

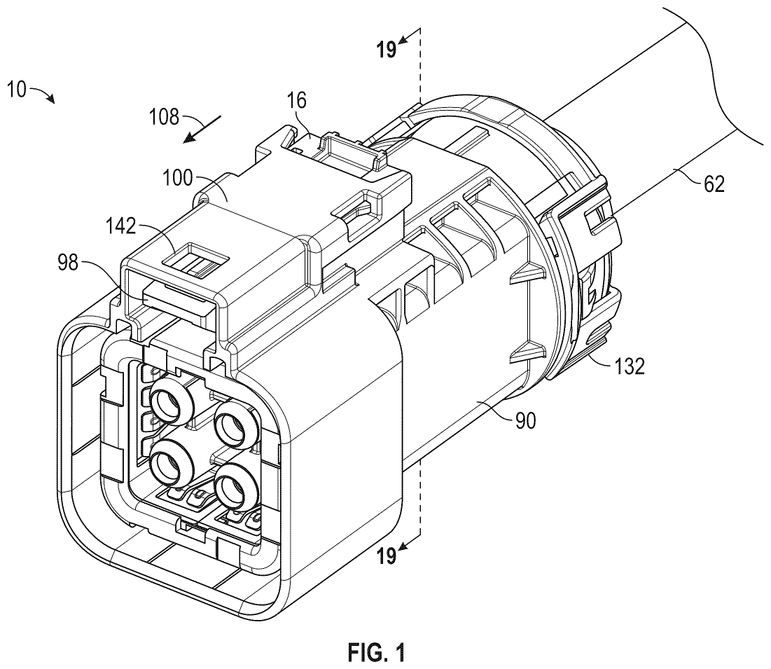

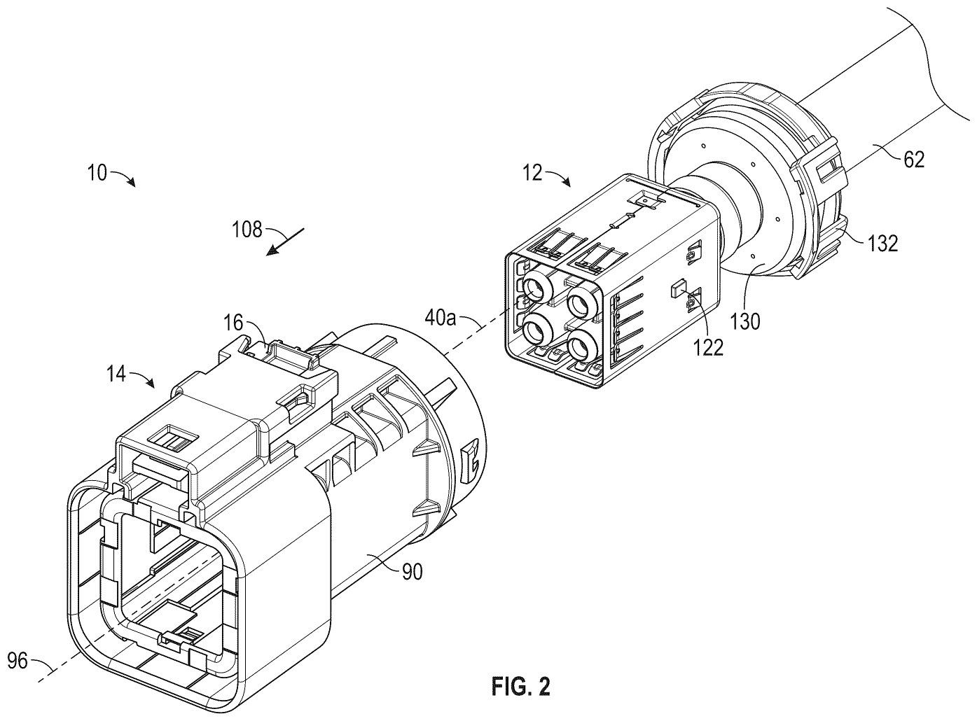

Referring now to the drawings there is illustrated in FIG. 1 a front perspective view of an electrical connector, indicated generally at 10. FIG. 2 is a partially exploded view of the electrical connector 10, showing an inner assembly, indicated generally at 12, and an outer assembly, indicated generally at 14, that includes a connector position assurance 16.

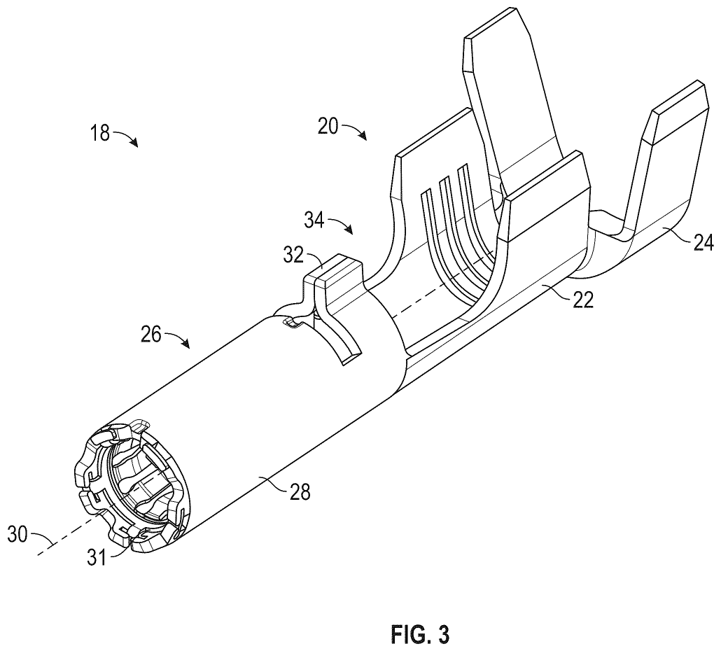

Referring to FIG. 3, there is illustrated a front perspective view of an electrical terminal, indicated generally at 18. The electrical terminal 18 is suitable for use with the electrical connector 10, as will be described below. The illustrated electrical terminal 18 is a female barrel type terminal, but may be any desired type of electrical terminal. The illustrated electrical terminal 18 is made from a piece of sheet metal that is folded into the illustrated shape. However, the electrical terminal 18 may be made of any desired material and by any desired process. The electrical terminal 18 includes a connection portion indicated at 20. The illustrated connection portion 20 is a crimp portion, and includes conductor crimp wings 22 and insulator crimp wings 24. However, the connection portion 20 may be any desired type of connector. The electrical terminal 18 also includes a contact portion, indicated at 26, which is attached to the crimp portion 20. The contact portion 26 includes a generally cylindrical barrel 28 that is located around a terminal axis 30. The contact portion 26 also includes a contact spring 31 that is attached to and located inside the barrel 28. The contact spring 31 is adapted to engage a corresponding male terminal (not shown) in order to establish an electrical connection between the corresponding male terminal and the barrel 28. The electrical terminal 18 includes a tab 32 that extends from the contact portion 26 in a direction substantially perpendicular to the terminal axis 30. In the illustrated embodiment, the tab 32 is made from two pieces of metal that define part of the barrel 28 that are both folded to be adjacent to each other and to extend substantially perpendicular to the terminal axis 30. The illustrated tab 32 is located at the end of the barrel 28 nearest the connection portion 20. A space 34 is located between the tab 32 and the conductor crimp wings 22.

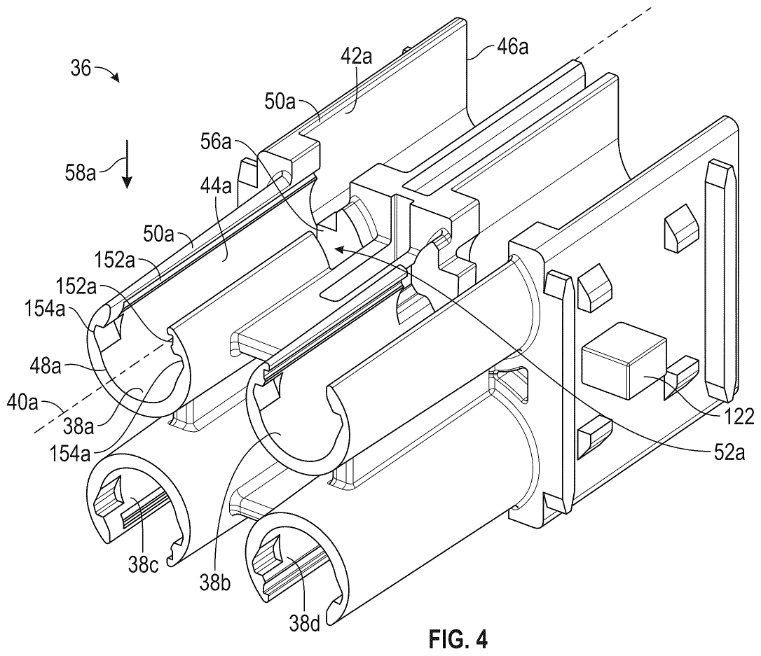

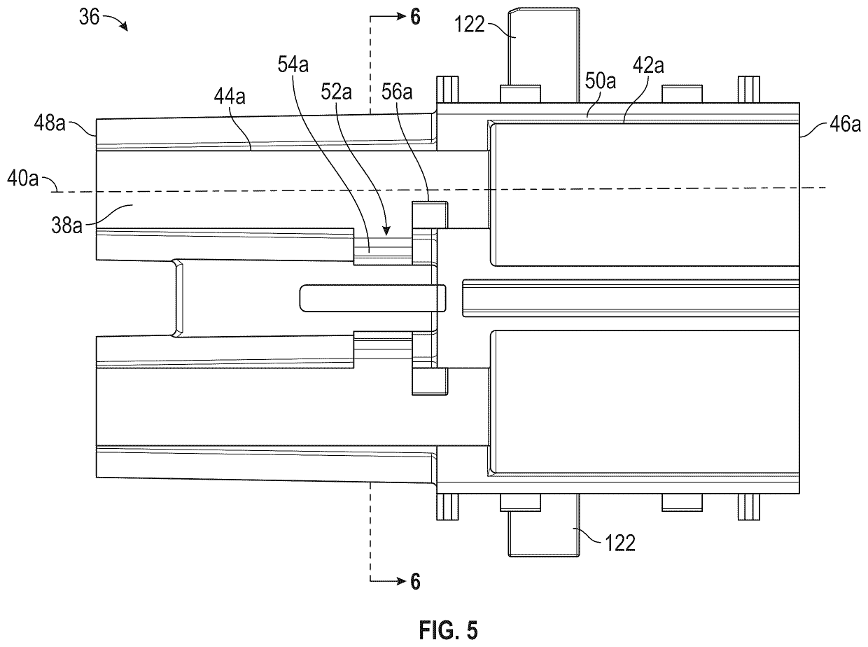

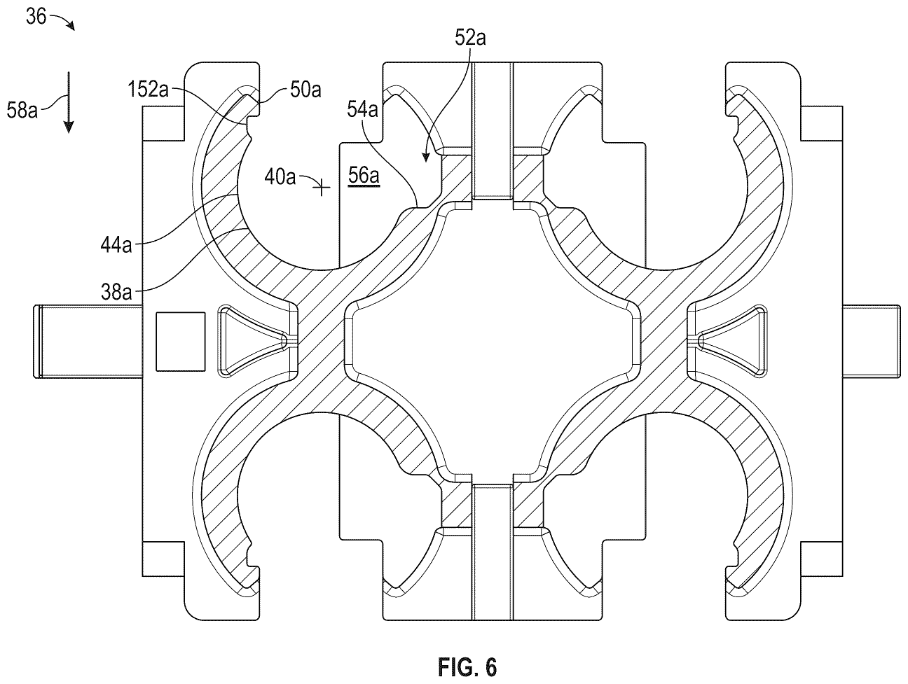

Referring to FIG. 4, there is illustrated a perspective view of a terminal housing, indicated generally at 36. The illustrated terminal housing 36 is molded from plastic, but may be made of any desired material and by any desired process. The illustrated terminal housing 36 includes four terminal cavities 38a, 38b, 38c, and 38d, and is configured to accommodate four terminals similar to the terminal 18. Each of the terminal cavities 38a, 38b, 38c, and 38d includes similar features and only one terminal cavity 38a will be described in detail. FIG. 5 is a top view of the terminal housing 36 and FIG. 6 is an end view of the terminal housing 36.

The terminal cavity 38a extends through the terminal housing 36 and defines a cavity axis 40a. The terminal cavity 38a includes a connection cavity 42a that is adapted to accommodate the connection portion 20 of the electrical terminal 18. The terminal cavity 38a also includes a contact cavity 44a that is adapted to accommodate the contact portion 26 of the electrical terminal 18. The connection cavity 42a is connected to the contact cavity 44a and the cavity axis 40a extends through both the connection cavity 42a and the contact cavity 44a. The connection cavity 42a defines a connection opening 46a at the end opposite the contact cavity 44a, and the cavity axis 40a passes through the connection opening 46a. Also, the contact cavity 44a defines a contact opening 48a at the end opposite the connection cavity 42a, and the cavity axis 40a passes through the contact opening 48a.

The terminal cavity 38a also defines an insertion opening 50a that is open to the connection cavity 42a and the contact cavity 44a. The insertion opening 50a is adapted to allow the electrical terminal 18 to be inserted into the terminal cavity 38a, as described below. In the illustrated embodiment, the insertion opening 50a extends the length of the terminal cavity 38a from the connection opening 46a to the contact opening 48a. However, the insertion opening 50a may have a shorter length, if desired.

The terminal cavity 38a includes a tab seat, indicated generally at 52a, that is connected to the contact cavity 44a. The tab seat 52a is an opening that extends from the contact cavity 44a and away from the cavity axis 40a. The tab seat 52a is adapted to accommodate the tab 32 on the electrical terminal 18 when the electrical terminal 18 is installed in the terminal cavity 38a. The tab seat 52a is open to the insertion opening 50a, and includes (as best shown in FIGS. 5 and 6) a seat surface 54a that is located on the opposite side of the tab seat 52a from the insertion opening 50a.

The terminal housing 36 includes a stop 56a that extends into the terminal cavity 38a. The stop 56a is adapted to retain the electrical terminal 18 in the terminal cavity 38a, as described below. The stop 56a is located between the tab seat 52a and the connection cavity 42a. The stop 56a is located adjacent to the tab seat 52a and extends toward the cavity axis 40a. The illustrated stop 56a is molded as part of the terminal housing 36 and is fixed relative to the terminal cavity 38a.

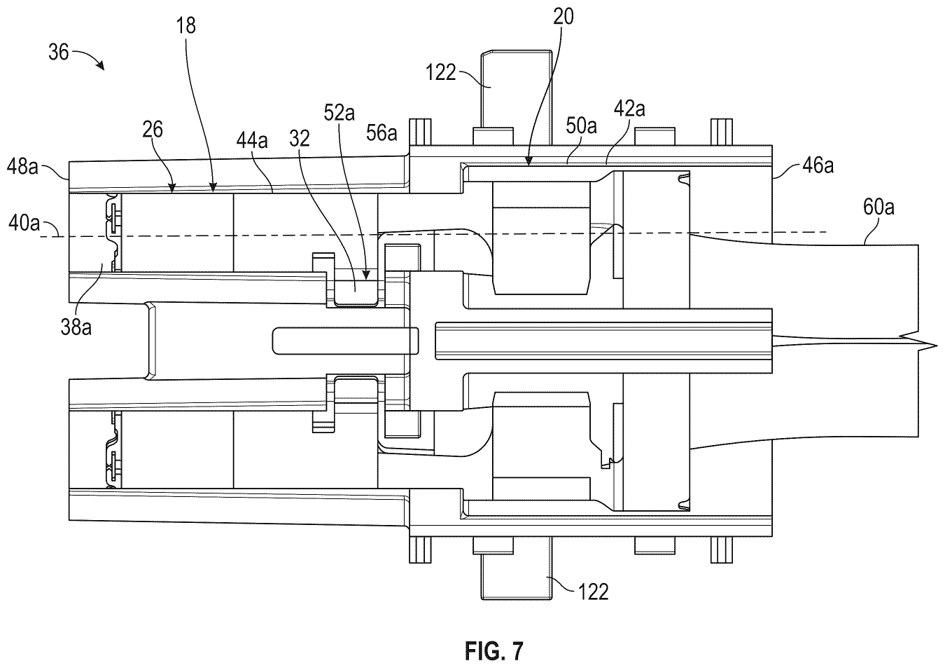

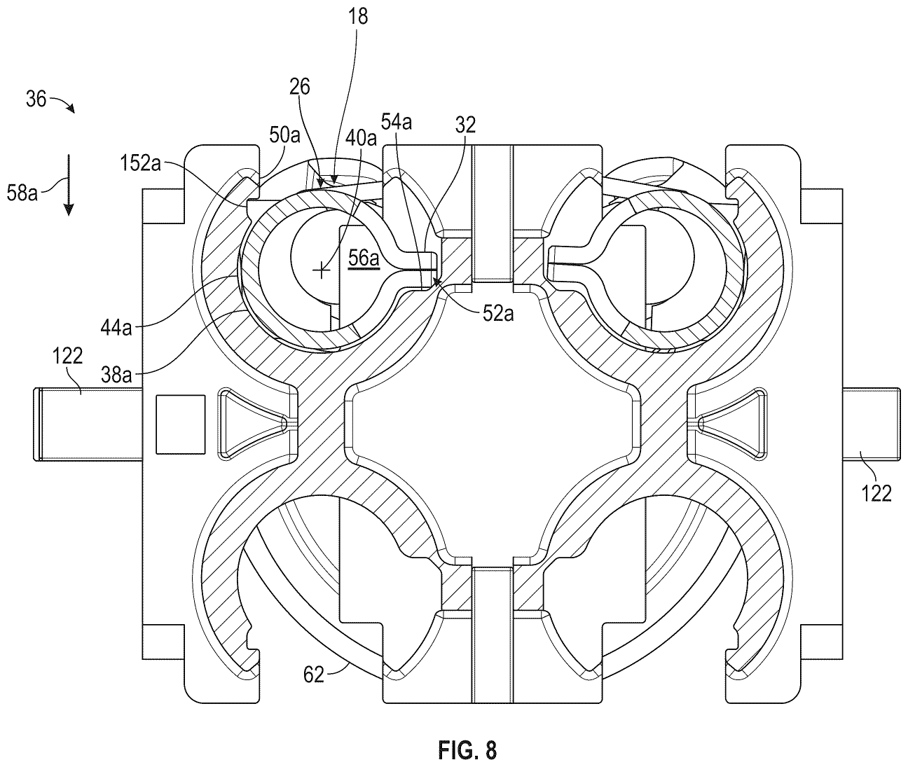

Referring to FIG. 7, there is illustrated a view similar to FIG. 5, with the electrical terminal 18 shown installed in the terminal housing 36. Additionally, FIG. 8 is a view similar to FIG. 6, with the electrical terminal 18 shown installed in the terminal housing 36. As shown, the electrical terminal 18 is located in the terminal cavity 38a. The connection portion 20 is located in the connection cavity 42a, the contact portion 26 is located in the contact cavity 44a, the tab 32 is located in the tab seat 52a, and the stop 56a is located in the space 34.

In order to install the electrical terminal 18 in the terminal cavity 38a, the electrical terminal 18 is positioned adjacent to the insertion opening 50a. The electrical terminal 18 is then moved in an insertion direction 58a, as shown in FIG. 8, relative to the to the terminal housing 36 through the insertion opening 50a to the position shown in FIGS. 7 and 8. The illustrated insertion direction 58a is substantially perpendicular to the cavity axis 40a. When the electrical terminal 18 is installed in the terminal housing 36, the terminal axis 30 is substantially parallel to the cavity axis 40a. As shown, the connection portion 20 of the electrical terminal 18 is connected to a wire 60a and when the electrical terminal 18 is installed in the terminal cavity 38a, the wire 60a extends out of the terminal cavity 38a through the connection opening 46a. The wire 60a is contained in the cable 62, shown in FIGS. 1 and 2.

As best shown in FIG. 7, the tab 32 positioned in the tab seat 52a provides a visual indication that the electrical terminal 18 properly positioned in the terminal cavity 38a. An operator is able to look through the insertion opening 50a into the tab seat 52a and see the tab 32. As shown in FIG. 8, the electrical terminal 18 is positioned in the terminal cavity 38a so that the tab 32 is adjacent to the seat surface 54a and the tab 32 is located between the seat surface 54a and the insertion opening 50a. As a result, at least part of the seat surface 54a is not visible through the insertion opening 50a.

As previously described, the stop 56a is adapted to retain the electrical terminal 18 in the terminal cavity 38a. When the electrical terminal 18 is installed in the terminal cavity 38a, the stop 56a is located in the space 34 between the tab 32 and the connection portion 20. When the electrical terminal 18 is installed in the terminal cavity 38a, a force applied to the cable 62 or the wire 60a will pull the electrical terminal 18 toward the connection opening 46a. The tab 32 and the barrel 28 will engage the stop 56a to prevent movement of the electrical terminal 18 towards the connection opening 46a relative to the terminal housing 36. Additionally, as shown in FIG. 8, the stop 56a extends from the seat surface 54a opposite the insertion direction 58a. As a result, if the electrical terminal 18 is rotated about the cavity axis 40a relative to the terminal housing 36, the tab 32 will still engage the stop 56a when the electrical terminal 18 is pulled towards the connection opening 46a relative to the terminal housing 36.

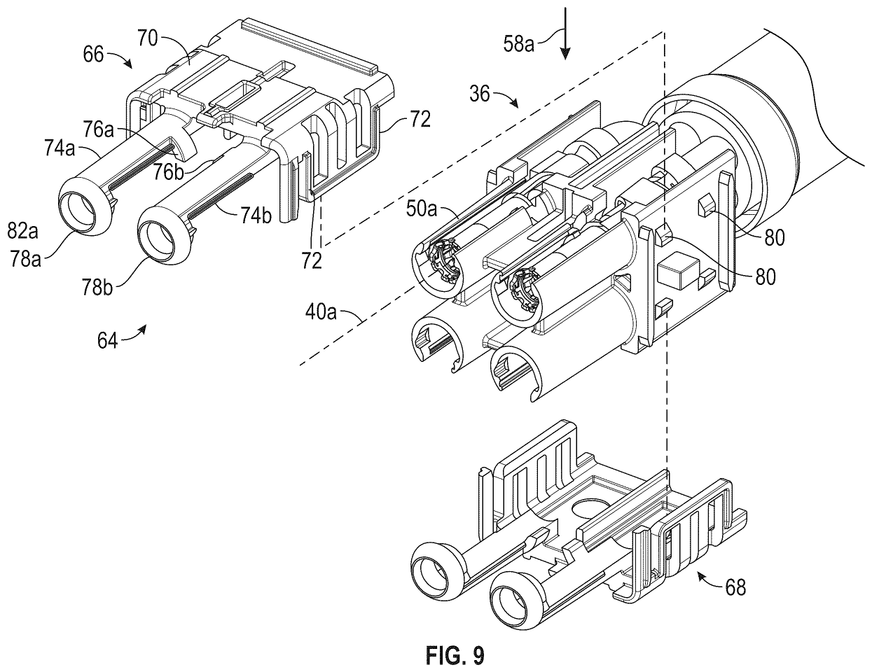

Referring now to FIG. 9, there is illustrated a front perspective view of the terminal housing 36 and a terminal position assurance, indicated generally at 64. The illustrated terminal position assurance (TPA) 64 includes two pieces, a first TPA piece, indicated generally at 66, and a second TPA piece, indicated generally at 68. However, the terminal position assurance 64 may include any desired number of pieces. The first TPA piece 66 and the second TPA piece 68 have similar features, and only the first TPA piece 66 will be described in detail.

The illustrated first TPA piece 66 is molded from plastic, but may be made from any desired material using any desired process. The first TPA piece 66 includes a TPA body 70. The first TPA piece 66 includes TPA latches 72 that extend from the TPA body 70. The illustrated first TPA piece 66 includes four U-shaped TPA latches 72 (two are visible in FIG. 9) that extend from the TPA body 70 in the insertion direction 58a. However, the first TPA piece 66 may include any desired number of any desired type of latch. The first TPA piece 66 includes a cavity cover 74a that extends from the TPA body 70 parallel to the cavity axis 40a. The illustrated first TPA piece 66 includes two cavity covers 74a and 74b, that are adapted to the cover the terminal cavities 38a and 38b, as described below. However, the first TPA piece 66 may include any desired number of cavity covers. The first TPA piece 66 includes a tab lock 76a that is adapted to retain the tab 32 in the tab seat 52a, as described below. The illustrated tab lock 76a extends from the cavity cover 74a, but may be located on any desired part of the first TPA piece 66. The tab lock 76a extends from the cavity cover 74a in the insertion direction 58a. The illustrated first TPA piece 66 includes two tab locks 76a and 76b, but only one is visible in FIG. 9. The first TPA piece 66 also includes a contact guides 78a and 78b. The contact guide 78a extends from an outer end of the cavity cover 74a, in the insertion direction 58a. The contact guide 78b extends from an outer end of the cavity cover 74b, in the insertion direction 58a.

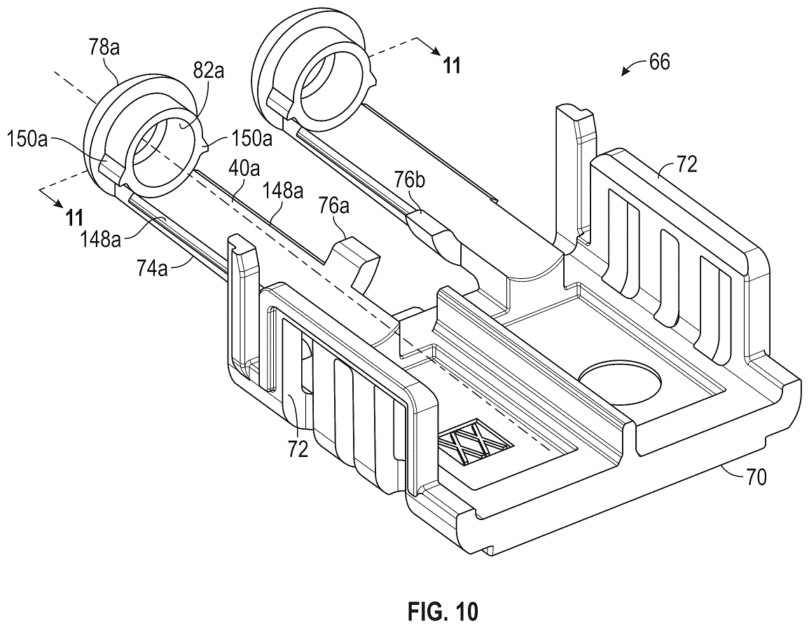

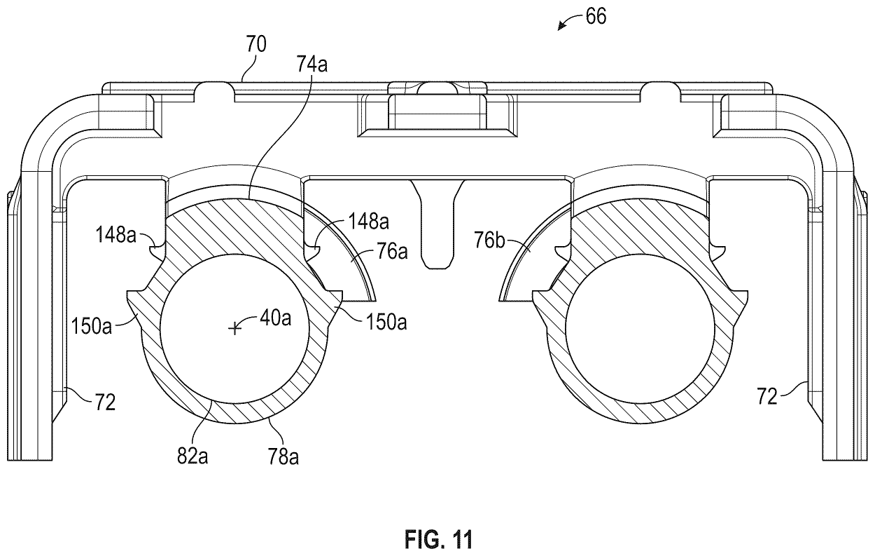

Referring to FIG. 10, there is illustrated an enlarged perspective view, from below, of the first TPA piece 66. FIG. 11 is a cross-sectional view taken along the line 11-11 in FIG. 10. The first TPA piece 66 includes a cover catch 148a located on the cavity cover 74a. As best shown on FIG. 11, the illustrated cavity cover 74a includes two cover catches 148a, located on opposite sides of the cavity cover 74a. The first TPA piece 66 also includes a guide catch 150a located on the contact guide 78a. The illustrated contact guide 78a includes two guide catches 150a, located on opposite sides of the contact guide 78a. The cover catches 148a and guide catches 150a are adapted to retain the first TPA piece 66 in position relative to the terminal housing 36, as described below.

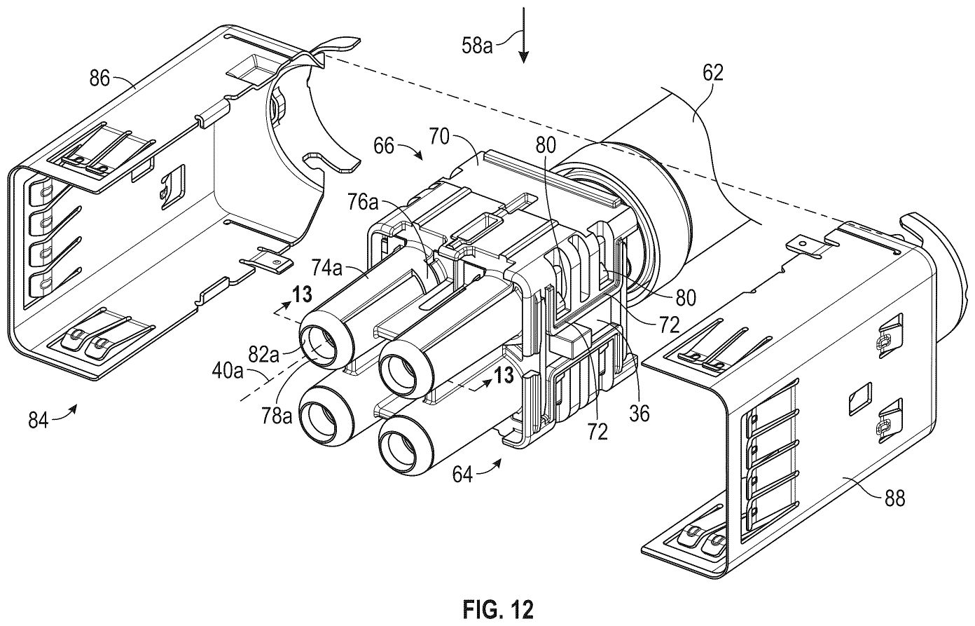

Referring to FIG. 12, there is illustrated a view similar to FIG. 9, with the terminal position assurance 64 shown installed on the terminal housing 36. In order to install the first TPA piece 66 on the terminal housing 36, the first TPA piece 66 is first positioned adjacent to the terminal housing 36 with the TPA latches 72 facing the terminal housing 36. The first TPA piece 66 is then moved in the insertion direction 58a relative to the terminal housing 36 so that the TPA latches 72 engage TPA catches 80 on the terminal housing 36. Each of the TPA latches 72 cooperates with the respective TPA catch 80 to retain the first TPA piece 66 in an installed position on the terminal housing 36, shown in FIG. 12. In this position, the first TPA piece 66 prevents the electrical terminal 18 from being moved opposite the insertion direction 58a relative to the terminal housing 36 out of the terminal cavity 38a.

When the first TPA piece 66 is in the installed position, the first TPA piece 66 covers the insertion opening 50a. In the illustrated embodiment, the TPA body 70 is located adjacent to the connection cavity 42a over a portion of the insertion opening 50a, and the cavity cover 74a is located adjacent to the contact cavity 44a over another portion of the insertion opening 50a. It should be appreciated that the illustrated cavity covers 74a are optional, and the TPA body 70 may cover the entire insertion opening 50a without the use of the additional cavity cover 74a.

Additionally, when the first TPA piece 66 is in the installed position, the tab lock 76a is located in the tab seat 52a and the tab 32 is located between the tab lock 76a and the seat surface 54a. Also, the contact guide 78a is located adjacent to the contact opening 48a of the terminal cavity 38a. The contact guide 78a defines a contact hole 82a and the cavity axis 40a passes through the contact hole 82a.

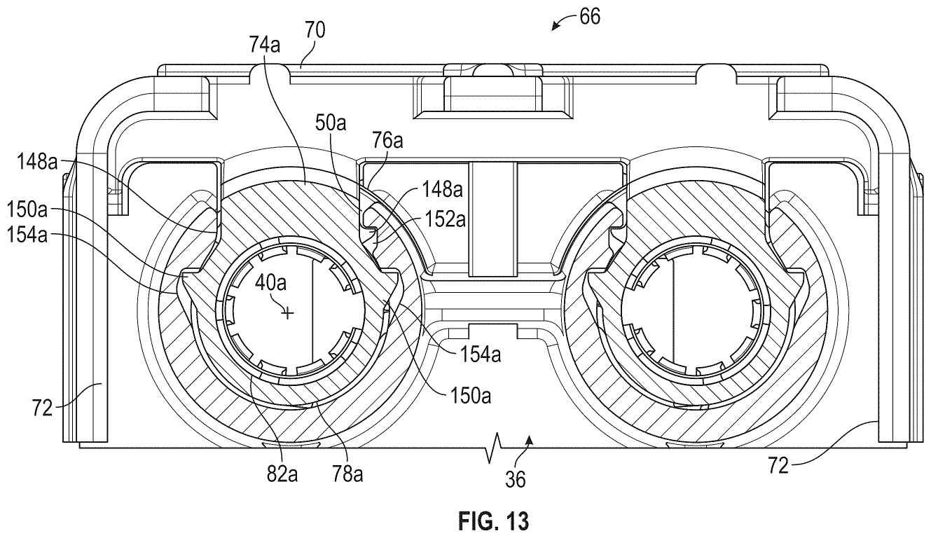

As best seen in FIG. 4, the terminal housing 36 includes two cover notches 152a, which are located on opposite sides of the insertion opening 50a. Additionally, terminal housing 36 includes two guide notches 154a, which are located adjacent to the contact opening 48a. Referring back to FIG. 12, the first TPA piece 66 is shown in the installed position; also, FIG. 13 is a cross-sectional view similar to FIG. 11 taken along the line 13-13 in FIG. 12. When the first TPA piece 66 is in the installed position, each of the cover catches 148a on the first TPA piece 66 is located in a respective one of the cover notches 152a. Each cover catch 148a engages the respective cover notch 152a in order to retain the cavity cover 74a in place relative to the insertion opening 50a. Additionally, each of the guide catches 150a is located in, and engaged with, a respective one of the guide notches 154a. Each guide catch 150a engages the respective guide notch 154a in order to retain the contact guide 78a in position relative to the contact opening 48a.

As previously described, the illustrated terminal housing 36 includes four terminal cavities 38a, 38b, 38c, and 38d, as shown in FIG. 4. When the illustrated first TPA piece 66 is in the installed position shown in FIG. 12, it acts as a terminal position assurance for both terminal cavities 38a and 38b. Additionally, the second TPA piece 68 is shown in an installed position in FIG. 12, where it acts as a terminal position assurance for both terminal cavities 38c and 38d. It should be appreciated that a second installation direction for the second TPA piece 68 is opposite the installation direction 58a, as a result of the second TPA piece 68 being on the opposite side of the terminal housing 36 from the first TPA piece 66.

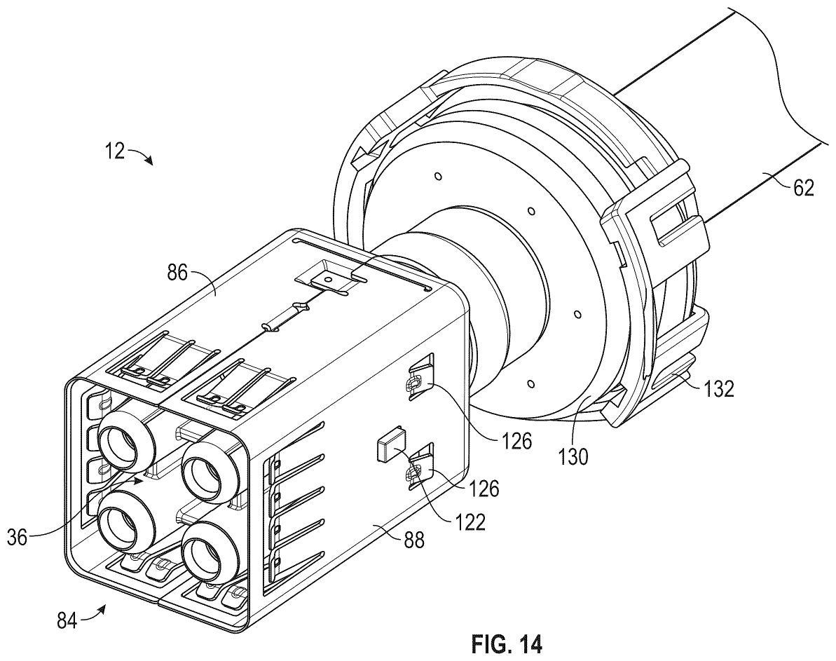

As also shown in FIG. 12, the electrical connector 10 includes a shield, indicated generally at 84. The illustrated shield 84 includes a first shield 86 and a second shield 88. The illustrated shield 84 is made of sheet metal folded into the illustrated shape. However, the shield 84 may be made of any desired material and by any desired process. FIG. 14 is a view similar to FIG. 12, showing the first shield 86 and the second shield 88 attached to each other around the terminal housing 36 so that the shield 84 is located around the terminal housing 36.

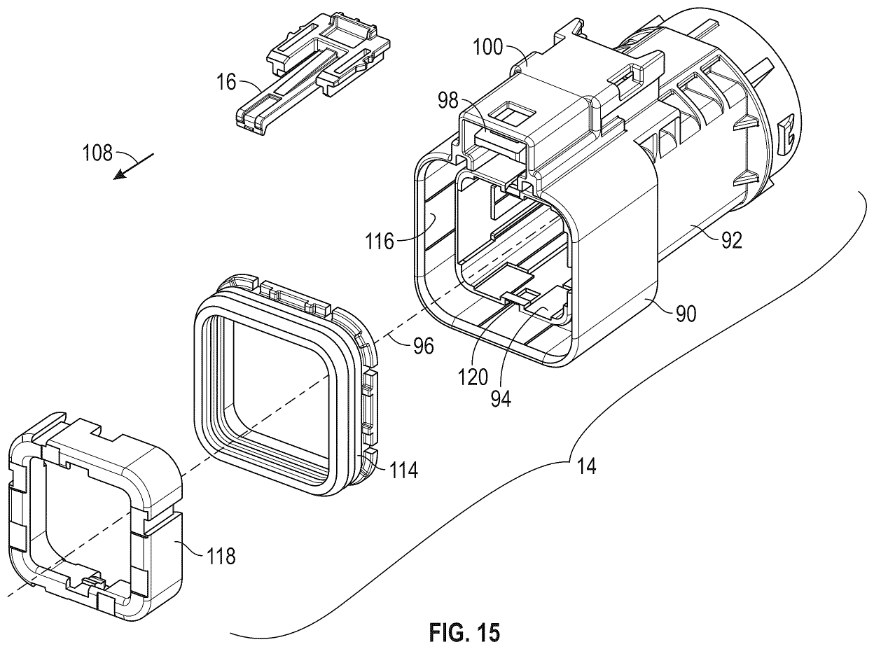

Referring now to FIG. 15, there is illustrated an exploded view of the outer assembly 14 from FIG. 2. The outer assembly 14 includes a connector housing 90. The illustrated connector housing 90 is molded from plastic but may be made of any desired material using any desired process. The connector housing 90 includes a connector body 92. A connector cavity 94 extends through the connector body 92 and defines a connector axis 96. The connector cavity 94 is adapted to accommodate the inner assembly 12, as described below.

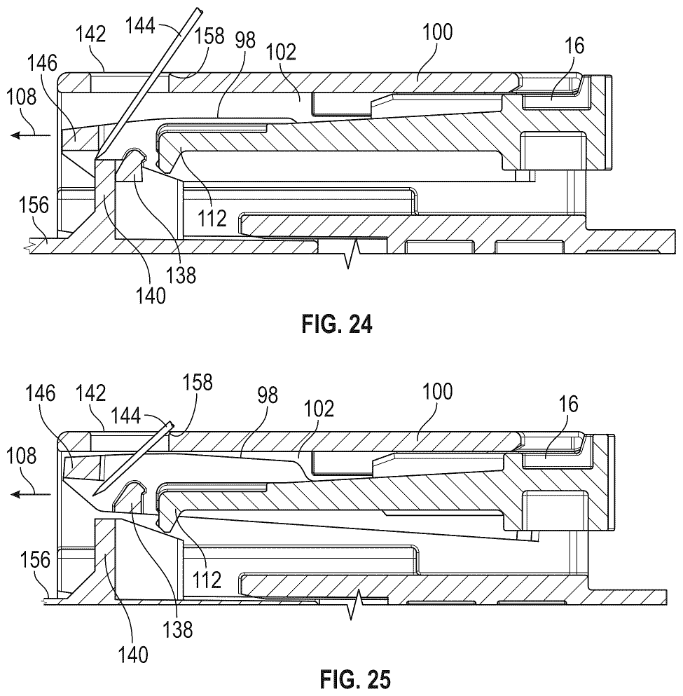

The connector housing 90 includes a latch 98 that is attached for movement relative to the connector body 92 between a latched position and release position. The latch 98 is moveable relative to the connector body 92 between a latched position and a release position. The latch 98 is adapted to retain the assembled electrical connector 10 in an installed position relative to a corresponding connector 156 (shown on FIG. 24), as described below. The connector housing 90 includes a shroud 100, and the latch 98 is located between the connector body 92 and the shroud 100.

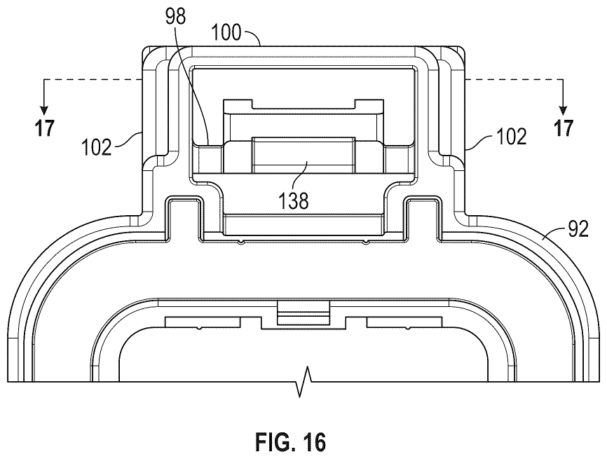

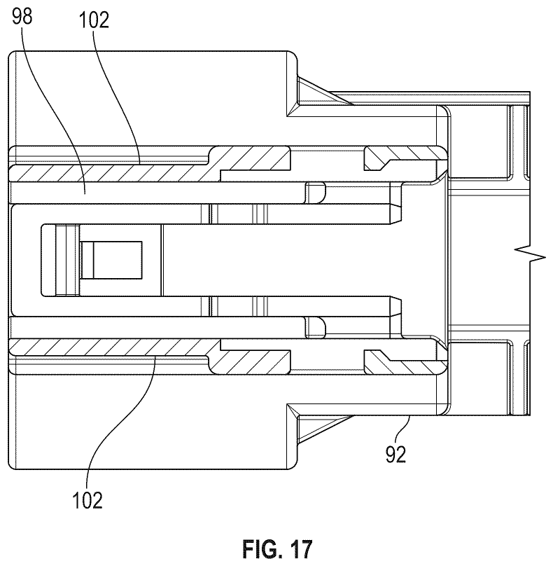

FIG. 16 is an enlarged end view of the connector housing 90, showing the latch 98, viewed parallel to the connector axis 96. FIG. 17 is a cross-sectional view taken along the line 17-17 in FIG. 16. The shroud 100 is attached to two shroud walls 102 that are attached to the connector body 92. The latch 98 is located between the two shroud walls 102. Additionally, the latch 98 is connected to the two shroud walls 102 and is able to be flexed to move relative to the shroud walls 102.

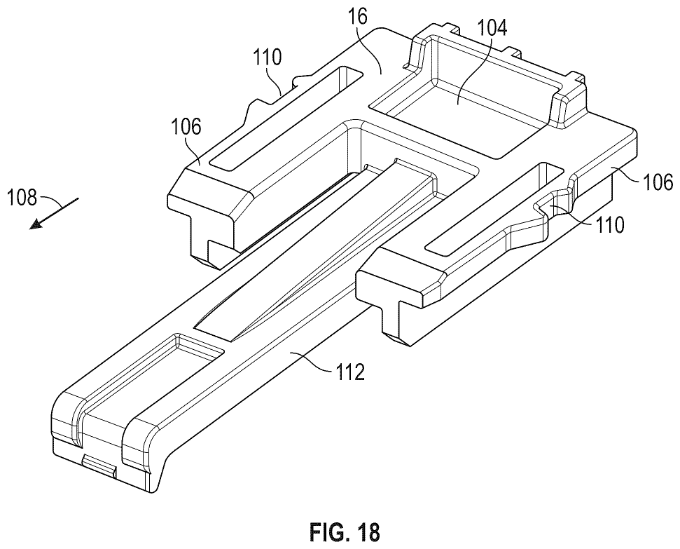

FIG. 18 is an enlarged front perspective view the connector position assurance 16 shown in FIG. 15. The illustrated connector position assurance 16 is molded from plastic but may be made from any material and by any desired process. The connector position assurance 16 includes an assurance body 104. Assurance guides 106 extend from the assurance body 104 in a mate direction 108. The illustrated connector position assurance 16 includes two assurance guides 106, which are located on opposite ends of the assurance body 104. The connector position assurance 16 includes assurance locks 110 that are adapted to retain the connector position assurance 16 in position relative to the latch 98, as described below. The illustrated connector position assurance 16 includes two assurance locks 110, and each is a resilient portion attached to one of the assurance guides 106. The connector position assurance 16 also includes an assurance arm 112 that extends from the assurance body 104 in the mate direction 108. The illustrated assurance arm 112 extends from the assurance body 104 between the two assurance guides 106.

Referring back to FIG. 15, the illustrated outer assembly 14 also includes a connector seal 114. The connector seal 114 is adapted to provide a seal between the electrical connector 10 and the corresponding connector 156, as shown in FIG. 24. In order to assemble the outer assembly 14, the connector seal 114 is moved opposite the mate direction 108 relative to the connector body 92 into a seal seat 116 that is located around the connector cavity 94. A seal retainer 118 is moved opposite the mate direction 108 relative to the connector body 92 and engages a retainer lock 120 on the connector body 92. The illustrated seal retainer 118 is molded from plastic but may be made of any desired material and by any desired process. The seal retainer 118 prevents the connector seal 114 from being removed from the seal seat 116. Additionally, the connector position assurance 16 is first positioned adjacent to the latch 98 and is moved in the mate direction 108 relative to the latch 98 to a pre-lock position. The assembled outer assembly 14 with the connector position assurance 16 in the pre-lock position is shown in FIG. 2. The operation of the connector position assurance 16 will be described below.

In order to assemble the electrical connector 10, the inner assembly 12 is attached to the outer assembly 14. As shown in FIG. 2, the inner assembly 12 is positioned adjacent to the connector housing 90 with the cavity axis 40a parallel to the connector axis 96. The inner assembly 12 is then moved in the mate direction 108 relative to the connector housing 90. The inner assembly 12 includes one of more assembly guides 122 (one is visible in FIG. 2) that extend from the inner assembly 12 perpendicular to the cavity axis 40a. As best shown in FIG. 5, the illustrated inner assembly 12 includes two assembly guides 122 that are part of the terminal housing 36. The illustrated assembly guides 122 extend from opposite sides of the terminal housing 36 and have different lengths. When the inner assembly 12 is assembled, the assembly guides 122 extend through the shield 84, as shown in FIG. 2.

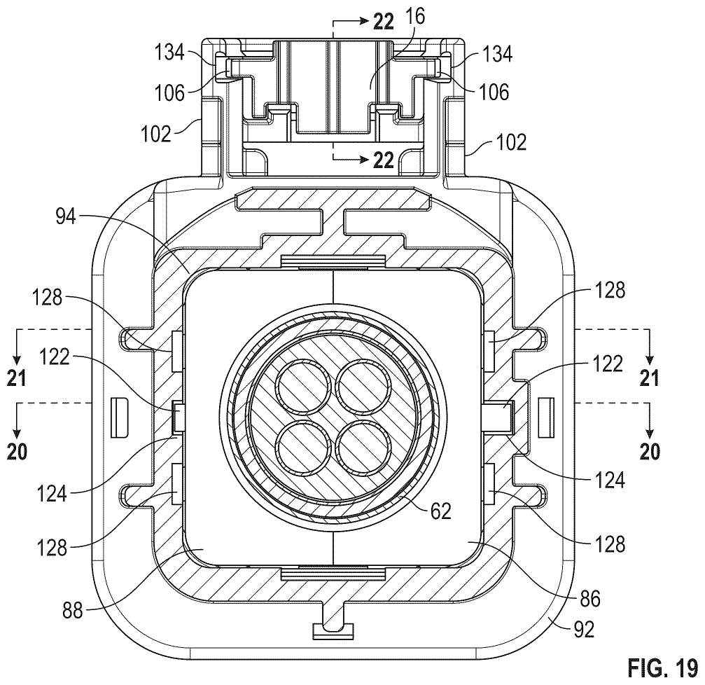

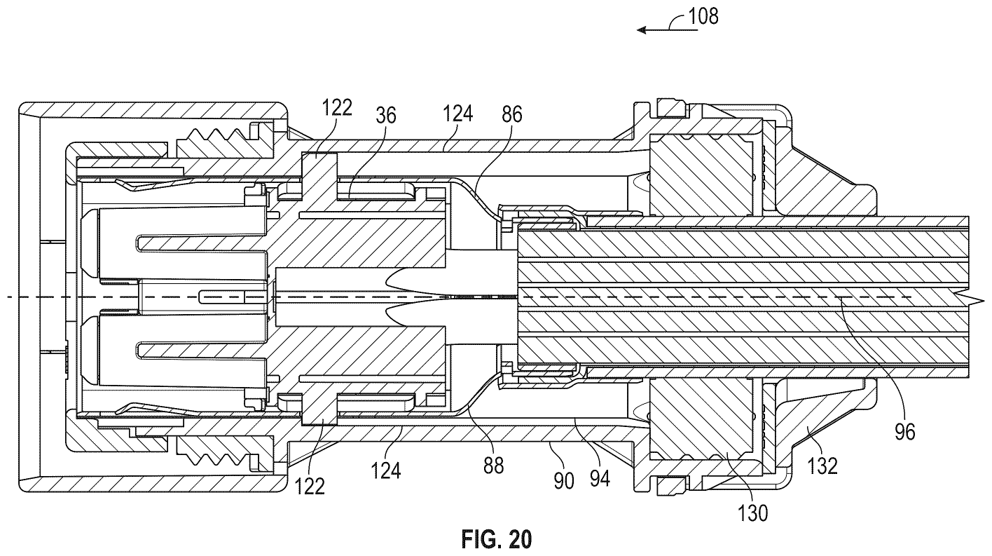

Referring now to FIG. 19, there is illustrated a cross-sectional view of the electrical connector 10 taken along the line 19-19 in FIG. 1. FIG. 20 is a cross-sectional view taken along the line 20-20 in FIG. 19. As shown, each assembly guide 122 is located in a respective guide channel 124 defined by the connector housing 90. The guide channels 124 are connected to the connector cavity 94 and extend parallel to the connector axis 96. The illustrated guide channels 124 are located on opposite sides of the connector cavity 94 and extend different distances from the connector axis 96. The different-length assembly guides 122 cooperate with the guide channels 124 to act as a poka-yoke feature to ensure that the inner assembly 12 is oriented in a desired position relative to the outer assembly 14 when the inner assembly 12 and the outer assembly 14 are attached to each other.

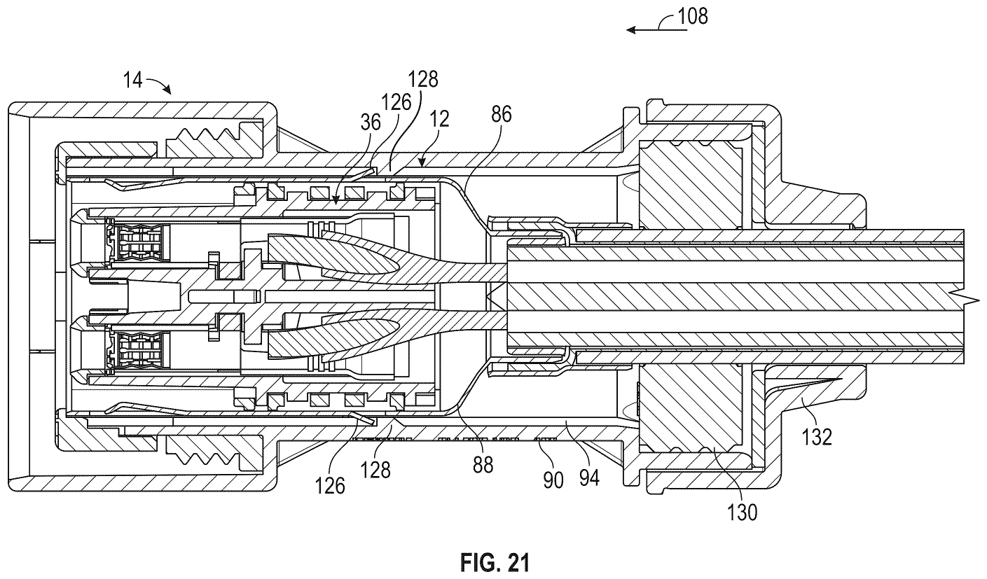

Referring to FIG. 21, a cross-sectional view taken along the line 21-21 in FIG. 19 is shown. When the inner assembly 12 is inserted into the outer assembly 14, assembly locks 126, as shown in FIG. 14, on the inner assembly 12 engage assembly catches 128 on the outer assembly 14 in order to retain the inner assembly 12 in place relative to the outer assembly 14. In the illustrated embodiment, the assembly locks 126 are metal lances bent from the shield 84 and the assembly catches 128 are molded tabs on the side of the connector cavity 94. Further, in the illustrated embodiment, the inner assembly 12 includes four assembly locks 126. As best shown on FIG. 14, two assembly locks 126 are visible on one side of the inner assembly 12, and two additional assembly locks 126 are on the hidden side of the inner assembly 12.

Referring back to FIG. 2, the electrical connector 10 also includes a cable seal 130 and an end cap 132 that are both located around the cable 62. In order to complete assembly of the electrical connector 10, the cable seal 130 is seated in the connector housing 90, and the end cap 132 engages the connector housing 90 in order to retain the cable seal 130 in position. The electrical connector 10 is then in the assembled state illustrated in FIG. 1.

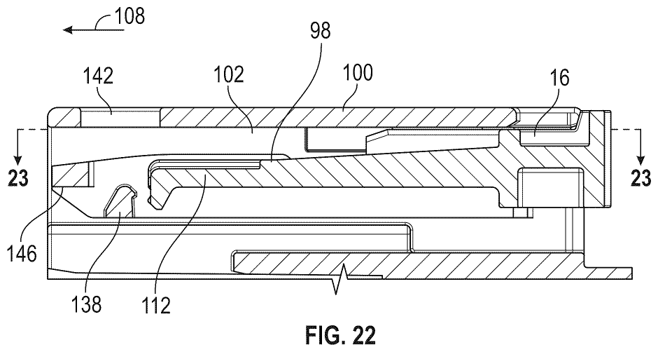

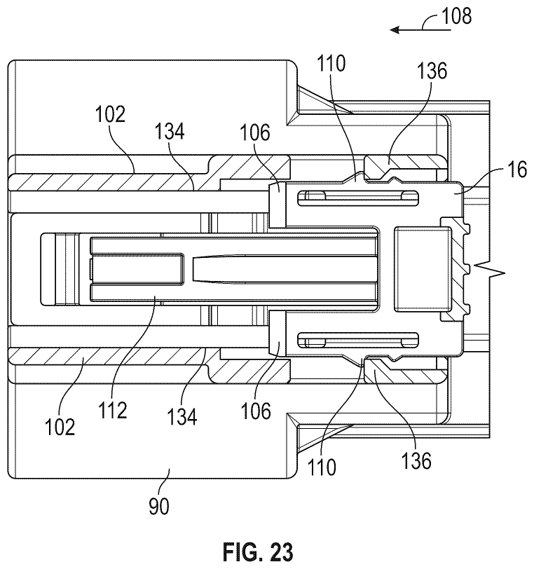

Referring now to FIG. 22, there is illustrated a cross-sectional view of the latch 98 and the connector position assurance 16, taken along the line 22-22 in FIG. 19. FIG. 23 is a cross-sectional view taken along the line 23-23 in FIG. 22. The connector position assurance 16 is shown in the pre-lock position in FIGS. 22 and 23. As shown in FIG. 19, each of the assurance guides 106 is located in a respective assurance slot 134. The assurance slots 134 are located on opposite sides of the connector position assurance 16. Each assurance slot 134 is defined by one of the shroud walls 102. The assurance guides 106 are able to be moved in the respective assurance slots 134 parallel to the mate direction 108 to allow the connector position assurance 16 to be moved relative to the connector housing 90.

As shown in FIG. 23, each of the assurance locks 110 engages a respective assurance catch 136 in order to retain the connector position assurance 16 in the pre-lock position relative to the connector housing 90. The assurance catches 136 are located on opposite sides of the connector position assurance 16. Each assurance catch 136 is located on one of the shroud walls 102. Additionally, the assurance arm 112 engages a block 138 on the latch 98 in order to prevent the connector position assurance 16 from being moved in the mate direction 108 relative to the connector housing 90.

Referring to FIG. 24, there is illustrated a view similar to FIG. 22, shown when the electrical connector 10 is being mated with the corresponding connector 156. When the electrical connector 10 is mated with the corresponding connector 156, the electrical connector 10 is initially positioned adjacent to the corresponding connector 156, and is then moved in the mate direction 108 relative to the corresponding connector 156 to an partially mated position shown in FIG. 24. A corresponding catch 140 on the corresponding connector 156 engages the block 138 on the latch 98, and prevents farther movement of the electrical connector 10 relative to the corresponding connector 156 in the mate direction 108. The latch 98 is adapted to prevent the electrical connector 10 from being moved beyond the partially mated position relative to the corresponding catch 140 without additional manual operation.

As best shown in FIG. 1, the shroud 100 defines a window 142. In order to move the electrical connector 10 farther in the mate direction 108 relative to the corresponding catch 140, the operator may insert a tool 144 through the window 142 to engage a lift bar 146 on the latch 98. The illustrated tool 144 is a screwdriver but may be any desired type of device. The window 142 includes a pry surface 158 on which the operator may rest the tool 144 to act as a fulcrum in order to apply a levered force on the lift bar 146.

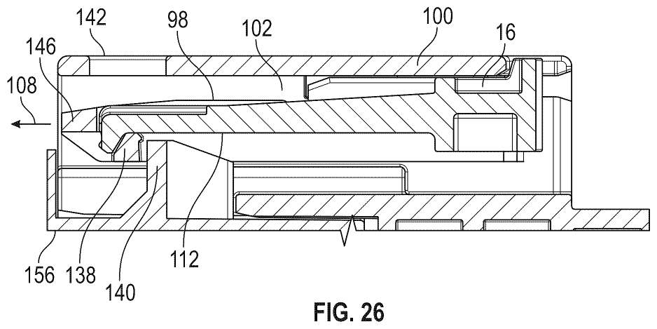

As shown in FIG. 25, by applying a force on the lift bar 146, the latch 98 is able to be moved relative to the connector body 92 to a release position. This which also moves the block 138 relative to the connector body 92 and relative to the corresponding catch 140. When the latch 98 is in the release position, the electrical connector 10 is able to be moved relative to the corresponding catch 140 in the mate direction 108 to a mated position, shown in FIG. 26. The operator may then release the force on the lift bar 146 to allow the latch 98 to return to the latched position shown in FIG. 26.

When the corresponding catch 140 is in the mated position, the connector position assurance 16 is able to be moved in the mate direction 108 relative to the connector housing 90 to a lock position, which is also shown in FIG. 26. In the lock position, the assurance arm 112 engages the block 138 to restrict the connector position assurance 16 from being moved opposite the mate direction 108 relative to the connector housing, and thereby hold the connector position assurance 16 in the lock position relative to the latch 98. Additionally, the assurance arm 112 is located at least partially between the window 142 and the lift bar 146 in order to prevent the tool 144 from being used to engage the lift bar 146.

As also shown in FIG. 26, the latch 98 is adapted to prevent the electrical connector 10 from being moved from the mated position relative to the corresponding catch 140 without additional manual operation. In order to disconnect the electrical connector 10 from the corresponding connector 156, the previous operation is reversed. The connector position assurance 16 is moved from the lock position, opposite the mate direction 108 to the pre-lock position. The tool 144 may then be inserted through the window 142 to engage the lift bar 146 in order to raise the latch 98 to the release position, as shown in FIG. 25. The electrical connector 10 may then be moved opposite the mate direction 108 relative to the corresponding catch 140 to the partially mated position shown in FIG. 24.

It should be appreciated that in the illustrated embodiment, the lift bar 146 is located on a distal end of the latch 98 in order to provide mechanical advantage when the operator uses the tool 144 to lift the latch 98. However, the lift bar 146 may be located on any desired part of the latch 98. Additionally, any desired part of the connector position assurance 16 may be used to interfere with operation of the lift bar 146 when the connector position assurance 16 is in the lock position.

Those with ordinary skill in the art will appreciate that various modifications and alternatives for the described and illustrated embodiments can be developed in light of the overall teachings of the disclosure, and that the various elements and features of one example described and illustrated herein can be combined with various elements and features of another example without departing from the scope of the invention. Accordingly, the particular examples disclosed herein have been selected by the inventor(s) simply to describe and illustrate examples of the invention and are not intended to limit the scope of the invention or its protection, which is to be given the full breadth of the appended claims and any and all equivalents thereof.

What is claimed is:

1. An electrical connector comprising:
a connector housing comprising a connector body, a connector cavity, a shroud, and a latch;
the connector cavity extending through the connector body;
the shroud connected to the connector body by at least one shroud wall, the shroud defining a window; and
the latch attached to the connector housing and moveable relative to the connector body between a latched position and a release position, the latch located at least partially between the shroud and the connector body, the latch comprises a block and a lift bar, the block adapted to engage a corresponding catch on a corresponding connector to retain said electrical connector in a mated position relative to the corresponding connector, the lift bar located between the window and the connector body.

2. The electrical connector of claim 1, wherein the latch is connected to two shroud walls for movement relative to the connector body.

3. The electrical connector of claim 1, wherein the window is adapted to allow a tool to be inserted through the window to engage the lift bar.

4. The electrical connector of claim 3, wherein the connector cavity defines a connector axis;
further comprising a connector position assurance attached to the connector housing for relative movement parallel to the connector axis between a pre-lock position and a lock position, the connector position assurance comprising an assurance body and an assurance arm that extends from the assurance body parallel to the connector axis;
wherein the assurance arm engages the block to prevent movement of the connector position assurance to the lock position when the connector position assurance is in the pre-lock position, and the assurance arm is adapted to prevent the tool from engaging the lift bar when the connector position assurance is in the lock position.

5. The electrical connector of claim 1, wherein the connector cavity defines a connector axis;
further comprising a connector position assurance attached to the connector housing for relative movement parallel to the connector axis between a pre-lock position and a lock position, the connector position assurance comprising an assurance body and an assurance arm that extends from the assurance body parallel to the connector axis;
wherein the assurance arm engages the block to prevent movement of the connector position assurance to the lock position when the connector position assurance is in the pre-lock position, and the assurance arm is positioned at least partially between the lift bar and the window when the connector position assurance is in the lock position.

6. The electrical connector of claim 1, wherein the connector cavity defines a connector axis;
wherein two shroud walls define respective assurance slots that extend parallel to the connector axis;
further comprising a connector position assurance attached to the connector housing for relative movement parallel to the connector axis between a pre-lock position and a lock position, the connector position assurance comprising an assurance body, and assurance guides located on opposite sides of the assurance body, with each assurance guide of the assurance guides located in a respective assurance slot.

7. The electrical connector of claim 6, the connector position assurance further comprising an assurance lock located on each of the assurance guides;
wherein each assurance guide of the assurance guides engages a respective assurance catch to retain the connector position assurance in the pre-lock position.

8. The electrical connector of claim 1, wherein the connector cavity defines a connector axis;
further comprising a connector position assurance attached to the connector housing for relative movement parallel to the connector axis between a pre-lock position and a lock position, the connector position assurance comprising an assurance body and an assurance arm that extends from the assurance body parallel to the connector axis;
wherein the assurance arm engages the block to prevent movement of the connector position assurance to the lock position when the connector position assurance is in the pre-lock position, and the assurance arm is positioned at least partially between the lift bar and the window when the connector position assurance is in the lock position.

9. The electrical connector of claim 1, further comprising a terminal housing located in the connector cavity that comprises a terminal cavity adapted to accommodate an electrical terminal, the terminal cavity defining a cavity axis that extends through a contact opening of the terminal cavity and also extends through a connection opening of the terminal cavity, an insertion opening that extends from the terminal cavity and is adapted to allow the electrical terminal to be inserted into the terminal cavity in an insertion direction that is substantially perpendicular to the cavity axis.

10. The electrical connector of claim 9, further comprising a terminal position assurance that is movable relative to the terminal housing in the insertion direction to an installed position wherein a TPA latch engages a TPA catch to retain the terminal position assurance in the installed position, and wherein the terminal position assurance covers the insertion opening.

11. The electrical connector of claim 10, the terminal position assurance further comprising a contact guide that is located adjacent to the contact opening, the contact guide defines a contact hole and the cavity axis passes through the contact hole.

12. An electrical connector comprising:
a connector housing comprises a connector body and a connector cavity extending through the connector body;
a terminal housing located in the connector cavity that comprises a terminal assurance catch and a terminal cavity, the terminal cavity adapted to accommodate an electrical terminal, the terminal cavity having a contact opening, a connection opening, an insertion opening, and defining a cavity axis that extends through the contact opening and through the connection opening, the insertion opening extending from the terminal cavity and adapted to allow the electrical terminal to be inserted into the terminal cavity in an insertion direction substantially perpendicular to the cavity axis; and
a terminal position assurance that is movable relative to the terminal housing in the insertion direction to an installed position wherein a TPA latch engages a TPA catch to retain the terminal position assurance in the installed position, and wherein the terminal position assurance covers the insertion opening.

13. The electrical connector of claim 12, the terminal position assurance further comprising a TPA body and a cavity cover that extends from the TPA body and that covers at least part of the insertion opening, the cavity cover comprising cover catches on opposite sides that each engage a respective cover notch on the terminal housing.

14. The electrical connector of claim 13, the terminal position assurance further comprising a contact guide that is attached to the cavity cover and that is located adjacent to the contact opening, the contact guide defines a contact hole and the cavity axis passes through the contact hole, the contact guide comprising two guide catches that are engaged with respective guide notches on the terminal housing.

15. The electrical connector of claim 12, the terminal housing further comprising a tab seat that extends from the terminal cavity and is adapted to accommodate a tab on the electrical terminal and the terminal position assurance further comprising a tab lock that extends partially into the tab seat.

16. The electrical connector of claim 15, the terminal housing further comprising a stop that is fixed relative to the terminal cavity and that extends from a wall of the terminal cavity toward the cavity axis and is located between the tab seat and the connection opening.

17. The electrical connector of claim 12, the terminal position assurance further comprising a contact guide that is located adjacent to the contact opening, the contact guide defines a contact hole and the cavity axis passes through the contact hole.

18. The electrical connector of claim 17 the contact guide comprising two guide catches that are engaged with respective guide notches on the terminal housing.

19. The electrical connector of claim 12, wherein the connector housing comprises a shroud and a latch, the shroud connected to the connector body by a shroud wall, the shroud defining a window, the latch attached to the connector housing and moveable relative to the connector body between a latched position and a release position, the latch located at least partially between the shroud and the connector body, the latch comprising a block and a lift bar, the window adapted to allow a tool to be inserted through the window to engage the lift bar.

20. An electrical connector comprising:
a terminal housing that includes a terminal cavity adapted to accommodate an electrical terminal, the terminal cavity having a contact opening, a connection opening, an insertion opening, a tab seat, a stop, and defining a cavity axis that extends through the contact opening and through the connection opening, the insertion opening extending from the terminal cavity and adapted to allow the electrical terminal to be inserted into the terminal cavity in an insertion direction substantially perpendicular to the cavity axis, the tab seat extending from the terminal cavity and adapted to accommodate a tab on the electrical terminal, the stop fixed relative to the terminal cavity and extending from a wall of the terminal cavity toward the cavity axis, the stop located between the tab seat and the connection opening;
a terminal position assurance movable relative to the terminal housing in the insertion direction to an installed position wherein the terminal position assurance covers the insertion opening, the terminal position assurance including a TPA latch that engages a TPA catch on the terminal housing to retain the terminal position assurance in the installed position, a tab lock that extends partially into the tab seat, and a contact guide that is located adjacent to the contact opening, the contact guide defining a contact hole and the cavity axis passes through the contact hole;
a shield located around the terminal housing and the terminal position assurance;
a connector housing including a connector body, a shroud, and a latch, the connector body defining a connector cavity, the connector cavity extending through the connector body and defining a connector axis, the shroud connected to the connector body by two shroud walls, each shroud wall defining an assurance slot that extends parallel to the connector axis, the shroud defining a window, the latch located at least partially between the shroud and the connector body, the latch connected to the shroud walls and moveable relative to the connector body between a latched position and a release position, the latch including a block and a lift bar, the window adapted to allow a tool to be inserted through the window to engage the lift bar; and
a connector position assurance attached to the connector housing for relative movement parallel to the cavity axis between a pre-lock position and a lock position, the connector position assurance including an assurance body, assurance guides located on opposite sides of the assurance body, each assurance guide of the assurance guides located in a respective assurance slot, an assurance lock located on each of the assurance guides, and an assurance arm that extends from the assurance body parallel to the cavity axis;
wherein the block on the latch is adapted to engage a corresponding catch on a corresponding connector to retain the electrical connector in a mated position relative to the corresponding connector;
wherein the terminal housing located in the connector cavity with the cavity axis parallel to the connector axis, assembly locks on the shield engage the connector body to retain the terminal housing in place relative to the connector housing; and
wherein the assurance arm engages the block on the latch to restrict the connector position assurance from being moved in a mate direction that is parallel to the cavity axis relative to the connector housing when the connector position assurance is in the pre-lock position; and
wherein the assurance arm engages the block to prevent the connector position assurance from being moved opposite the mate direction relative to the connector housing and the assurance arm is located at least partially between the lift bar and the window when the connector position assurance is in the lock position.
